(19) United States
(12) Patent Application Publication
(10) Pub. No.: US 2006/0156600 A1
(43) Pub. Date: Jul. 20, 2006

(54) Apparatus and method for securing a pole to a vehicle

(76) Inventor: David G. Barker, Council Bluffs, IA (US)

Correspondence Address: KONDZELLA AND CYR, PONDVIEW PLAZA, SUITE 114, 5850 OPUS PARKWAY, MINNETONKA, MN, 55343, US

(21) Appl. No.: 11/035,519

(22) Filed: Jan. 15, 2005

(51) Int. Cl. G09F 21/04

(52) U.S. Cl. 40/591

(57) ABSTRACT

An apparatus and methods for mounting poles to vehicles is disclosed. The apparatus and method can permit the mounting one or more flagpoles to a receiver of a trailer hitch assembly of a vehicle. The apparatus can include an insert having an inner end and an outer end, the inner end configured to be received within the receiver of a vehicular mounted trailer hitch assembly with a support tube secured to the outer end of the insert, the support tube defining a support aperture configured to removably receive a flagpole. The flagpole may pass through the support tube and rests upon the ground, so that part of the weight of the flagpole is supported by the ground and part of the weight of the flagpole is supported by the apparatus.

### BACKGROUND OF THE INVENTION

1. Field of the Invention

The present invention relates generally to apparatus for mounting flagpoles to vehicles and, more particularly, an apparatus and method for mounting one or more flagpoles to a receiver of a trailer hitch assembly of a vehicle.

2. Description of the Related Art

The number of individuals attending sporting and other spectator events has increased dramatically over the last few decades. These events can range from football games and NASCAR races to steeple chases among other events and gatherings. The large numbers of individuals attracted to such events typically congregates in areas such as, for example, parking lots, in-fields, pits, and other surrounding locations before, after and during the events. This congregation typically creates a sea of people and vehicles dispersed in a loosely organized fashion. Finding someone or a particular location within this sea of people and vehicles is frequently difficult. Frequently, groups trying to identify their location erect a flag or other indicia from a flagpole to permit the identification of their location from afar. In most situations, larger and taller flagpoles more easily facilitate the identification of a particular location amidst the sea of people and vehicles. These flagpoles are typically temporarily secured adjacent to a particular group of people or vehicle. Therefore, a need exists for an apparatus and method to temporarily and securely support flagpoles.

Unfortunately, large flagpoles can be dangerous due to their size and mass. Most current commercially available devices are not adequate to safely support a large flagpole and the devices used which are currently available for supporting large flagpoles and other poles are typically cumbersome to use. Generally, the flagpoles size creates a hazard to the moving crowd of people around the apparatus at the gathering. To overcome this, spectators frequently temporarily secure flagpoles in stands or to their vehicles at the events. Some of the smaller stands for large flagpoles have been configured to be received under the wheel of a vehicle. However, these stands require the movement of the vehicle's wheel to be secured and removed and typically include a large plate that is cumbersome to store. Therefore, a need exists for an apparatus and method for stably supporting a flagpole that is compact and portable.

A number of smaller devices are also known for attaching flagpoles to a vehicle. Frequently, these smaller devices use suction cups or magnets to secure a small or miniature flagpole to a vehicle's body. Similarly, other vehicular flagpole mounting devices clamp to the edges on vehicle's body such as rain gutters and bumpers. Still other devices have secured flagpoles to vehicles' windows, and a wide variety of apparatus allow a flagpole to be mounted to the hood of a vehicle, the door of a vehicle, and to antennae. However, the smaller devices are typically not capable of stably securing the large flagpoles necessary to get attention at events where large crowds congregate. Therefore, a need exists for an apparatus and method for stably supporting large flagpoles sufficient to gain the desired attention when immersed in crowds of people.

Many vehicles such as trucks, sports utility vehicles (SUVs) and cars include a receiver type trailer hitch. These trailer hitches are generally designed to retain a trailer being pulled by the vehicle to which the trailer hitch is attached. The receiver portion of the hitch is rigidly attached to the underside of a vehicle and typically has a hollow rectangular tube projecting to the rear of the vehicle and parallel to the ground.

Many devices have been configured to utilize the receiver of a trailer hitch. Some of these devices are secured directly to the trailer hitch. These devices typically use clamps, magnets, and suction cups to mount to a portion of the hitch assembly. Other devices replace the hitch portion of the assembly and mount within the receiver. These devices typically include bicycle racks and other devices for increasing the amount of cargo hauled by the vehicle. In some cases, these devices may include a hitch portion integrated into their design.

Some devices configured to use a trailer hitch include small flagpoles. However, these devices are typically required to bear the entire weight of the flagpole as well as lateral forces and moments. Thus, the size of the flagpole that can be supported is limited by the structural integrity of the mount and the ability of the vehicle to carry the vertical as well as lateral forces and moments. Therefore, a need exists for a readily portable support system that would allow a large flagpole to be secured to a vehicle.

### SUMMARY OF THE INVENTION

An apparatus and method in accordance with the present invention may satisfy the above-listed needs by providing a simple portable apparatus and method for securing flagpoles and other pole mounted devices to a vehicle when presented in its simplest embodiment. The apparatus and method will also provide additional improvements and advantages that will be recognized by those skilled in the art upon review of the present disclosure.

In one aspect, the present invention provides an apparatus for supporting a flagpole. The apparatus including an insert and a support tube. The insert having an inner end and an outer end with the inner end configured to be received within the receiver of a trailer hitch assembly. The support tube is secured to the outer end of the insert. The support tube has a first end and a second end and defining a support aperture configured to removably receive a pole such as a flagpole. The support aperture extends from the first end to the second end of the support tube to permit the pole to extend through the support aperture. A sleeve may be secured within the support aperture. The sleeve can define a sleeve aperture to receive the pole. The sleeve may also have a first sleeve lip at a first sleeve end of the sleeve. The first sleeve lip may abut the first end of the support tube to prevent the sleeve from passing through the support aperture of the support tube. The support tube may be divided into a first element and a second element. The first element can be movably secured to the second element by a hinge to allow the first element and the second element to be moved between an open position and a closed position. The first element may define a first receiving surface and the second element may define a second receiving surface. The first receiving surface and the second receiving surface in turn may define the support aperture when the first element and the second element are positioned in the closed position. A latch assembly may also be provided to secure the first and the second element in a closed position. A first liner first may be secured to the first receiving surface and a second liner may be secured to the second receiving surface.

In another aspect, a plurality of support tubes may be provided on the apparatus. The support tubes may be secured to a support member. Generally, each of the plurality of support tubes has a first end and a second end and defines a support aperture configured to removably receive a flagpole. The support apertures may again extend from the first ends to the second ends of the support tubes to permit flagpoles to extend through the support apertures.

In yet another aspect, the present invention provides a method for supporting a pole. The method includes providing an apparatus for supporting the flagpole. The apparatus may include an insert having an inner end and an outer end. The inner end may be configured to be received within the receiver of a trailer hitch assembly. A support tube may be secured to the outer end of the insert. The support tube may have a first end and a second end and defining a support aperture configured to removably receive a flagpole. The support aperture can extend from the first end to the second end of the support tube to permit the flagpole to extend through the support aperture. The outer end of the insert is secured into a receiving of a trailer hitch assembly. A pole is then positioned through the support aperture of the support tube. The pole may be supported in a substantially vertical orientation.

It is thus an object of the present invention to provide novel apparatus and methods for securing a flagpole, umbrella or other poles for displaying signage or supporting various devices.

It may further be an object of the present invention to provide such novel apparatus and methods which can secure a flagpole in a simple operation.

It may further be an object of the present invention to provide such novel apparatus and methods to secure a flagpole while the flagpole rests on an underlying surface.

It may further be an object of the present invention to provide such novel apparatus and methods which can secure a flagpole in an upright position.

It may further be an object of the present invention to provide such novel apparatus and methods which can be portable.

It may further be an object of the present invention to provide such novel apparatus which can be lightweight.

It may further be an object of the present invention to provide such novel apparatus which can be lighted from a tail light receptacle.

It may further be an object of the present invention to provide such novel apparatus which can support a plurality of flagpoles.

It may further be an object of the present invention to provide such novel apparatus and methods which can be utilized in crowded spaces.

It may further be an object of the present invention to provide such novel apparatus and methods which can be simple to construct.

It may further be an object of the present invention to provide such novel apparatus which can be inexpensive to manufacture.

It may further be an object of the present invention to provide such novel apparatus and methods which can utilize a minimum of parts.

These and other objects, features, and advantages of the present invention will become more readily apparent to those skilled in the art upon review of the following detailed description of the invention in view of the drawings wherein like reference numerals refer to corresponding parts in the several views.

### BRIEF DESCRIPTION OF THE DRAWINGS

The illustrative embodiments may be best described by reference to the accompanying drawings where:

FIG. 1 illustrates a perspective view of an embodiment of an apparatus in accordance with the present invention attached to a vehicle;

FIG. 2 illustrates a perspective view of an embodiment of an apparatus in accordance with the present invention removed from the receiver of a trailer hitch assembly;

FIG. 3 illustrates a perspective view of an embodiment of an apparatus in accordance with the present invention removed from the receiver of a trailer hitch assembly;

FIG. 4 illustrates a top view of an embodiment of an apparatus in accordance the present invention positioned in the receiver of a trailer hitch assembly;

FIG. 5 illustrates a side view of an embodiment of an apparatus in accordance with the present invention positioned in the receiver of a trailer hitch assembly;

FIG. 6 illustrates a partial cross-section of an apparatus in accordance with the present invention through section A-A of FIG. 5 illustrating an embodiment of an insert secured inside a receiver;

FIG. 7 illustrates a partial cross section of an apparatus in accordance with the present invention through section B-B of FIG. 4 illustrating an embodiment of a support tube;

FIG. 8 illustrates a side view of another embodiment of an apparatus in accordance with the present invention including a sleeve positioned within the support tube;

FIG. 9 illustrates a partial cross section of an embodiment of an apparatus through section B-B of FIG. 4 in accordance with the present invention including a support tube divided into two semi-cylindrical elements;

FIG. 10 illustrates a partial cross section of another embodiment of an apparatus through section B-B of FIG. 4 in accordance with the present invention including a support tube divided into two semi-cylindrical elements;

FIG. 11 illustrates a side view of an embodiment of an apparatus in accordance with present invention showing the semi-circular elements in an open position; and

FIG. 12 illustrates a top view of an embodiment of an apparatus in accordance with present invention showing the semi-circular elements in a closed position;

FIG. 13 illustrates a side view of another embodiment of an apparatus in accordance with the present invention showing a first securing device fixed to the upper portion of the support tube and a second securing device fixed to the lower portion of the support tube;

FIG. 14 illustrates a top view of the embodiment of an apparatus in accordance with the present invention similar to the embodiment of FIG. 13 showing a securing device fixing a circular pole inside the support tube;

FIG. 15 illustrates an embodiment of an apparatus in accordance with the present invention supporting an umbrella;

FIG. 16 illustrates a top view of yet another embodiment of an apparatus in accordance with the present invention including a plurality of support tubes secured within a receiver in a horizontal position; and

FIG. 17 illustrates a front view of the embodiment of an apparatus in accordance with the present invention similar to the embodiment of FIG. 16 secured within a receiver in a vertical position.

All Figures are illustrated for ease of explanation of the basic teachings of the present invention only; the extensions of the Figures with respect to number, position, relationship and dimensions of the parts to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in various Figures of the drawings, the same numerals designate the same or similar parts. Furthermore, when the terms “top,” “bottom,” “right,” “left,” “forward,” “rear,” “first,” “second,” “inside,” “outside,” and similar terms are used, the terms should be understood to reference only the structure shown in the drawings as it would appear to a person viewing the drawings and utilized only to facilitate describing the illustrated embodiment.

### DETAILED DESCRIPTION OF THE INVENTION

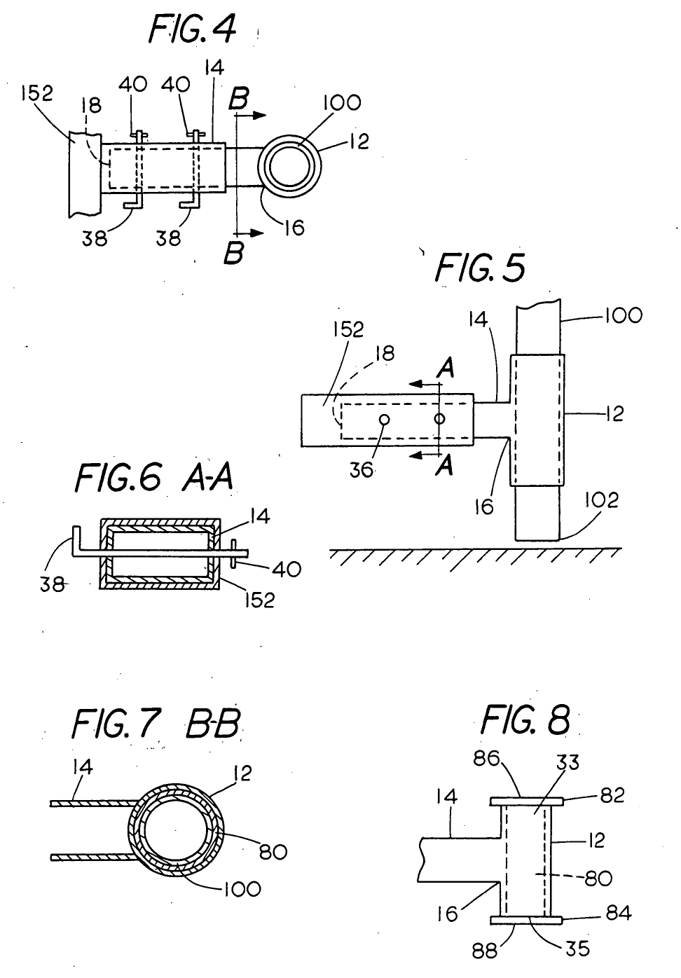

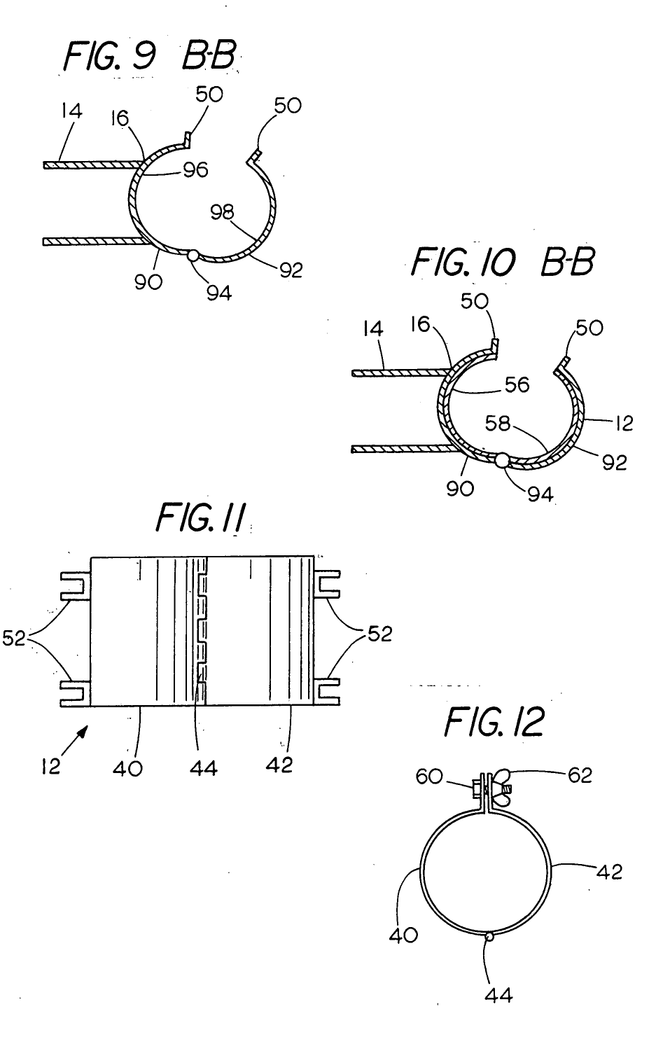

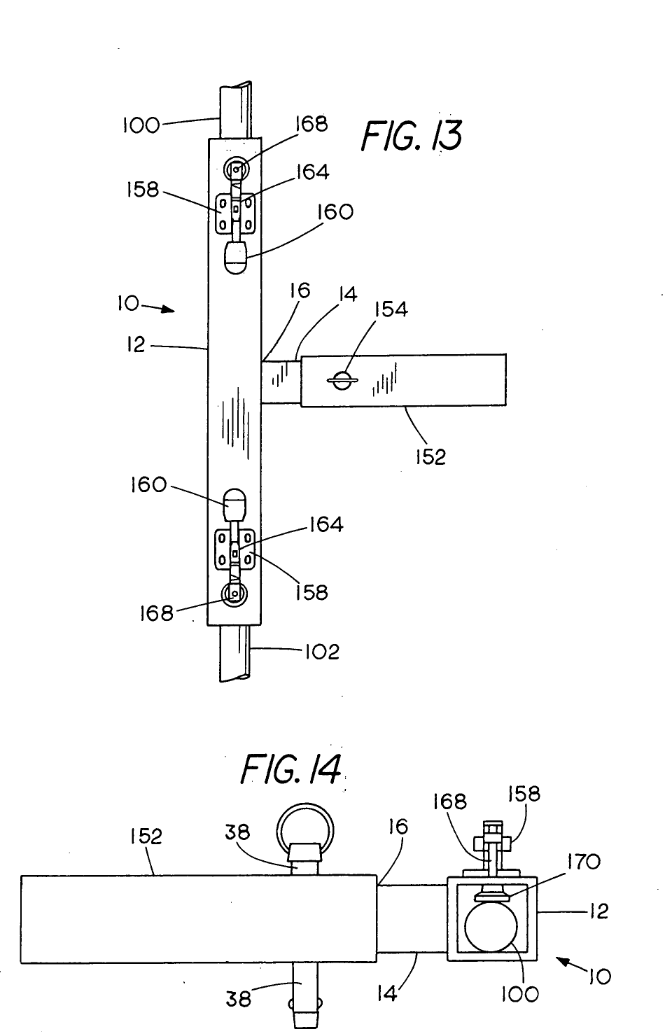

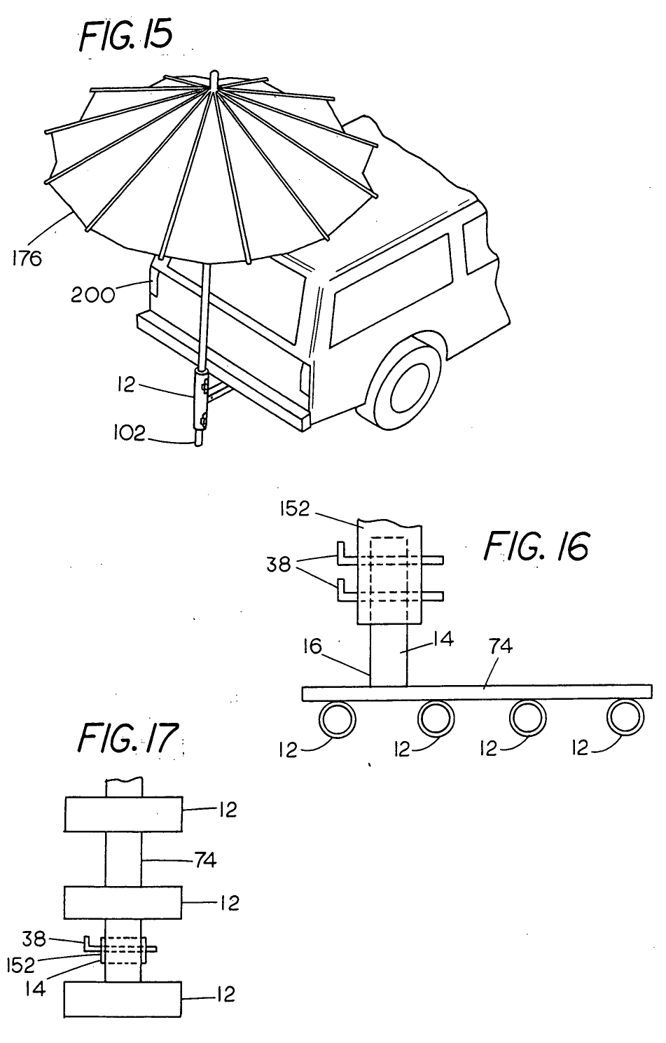

The present invention provides an apparatus and methods for securing a pole 100 to a vehicle 200. The principals of the present invention are generally illustrated by FIGS. 1 through 17 for exemplary purposes. An apparatus for practicing methods in accordance with the present invention is shown in the drawings and is generally designated 10. Apparatus 10 is generally configured to be rigidly attached to a receiver 152 of a trailer hitch assembly 150. Typically, trailer hitch 150 is attached to a vehicle 200 to provide a platform for securing a pole 100. Apparatus 10 supports pole 100 which passes through apparatus 10. A butt 102 of pole 100 typically rests upon the underlying surface. Typically, this underlying surface corresponds to the parking surface around vehicle 200. FIG. 1 illustrates an exemplary embodiment of an apparatus 10 secured within a receiver 152 of trailer hitch assembly 150 to a vehicle 200. A pole 100 is positioned through apparatus 10 in a position substantially perpendicular from the underlying surface for exemplary purposes. Accordingly, the weight of pole 100 may, at least in part, be supported by the underlying surface.

An apparatus 10 in accordance with the present invention generally includes a support tube 12 secured to an insert 14. Support tube 12 is generally configured to receive a pole 100 through a support aperture 20 defined by the support tube 12. Typically, support tube 12 is rigidly connected to the outside end 16 of insert 14 to permit apparatus 10 to support pole 100. However, support tube 12 may be secured to insert 14 to allow for the adjustment of the angle of support tube 12 relative to the underlying surface and/or insert 14. This adjustability can permit the positioning of pole 100 at a desired angle to the underlying surface. As will be recognized by one skilled in the art upon review of the present disclosure, apparatus 10 is typically composed of steel, aluminum, iron, nylon, carbon fiber, fiberglass, plastic or other material or composite of materials of sufficient mechanical strength to support pole 100 in various configuration of apparatus 10 in accordance with the present invention.

Support tube 12 generally defines a support aperture 20 to receive a pole 100. Support aperture 20 may extend from a first end 22 of support tube 12 to a second end 24 of support tube 12. Support aperture 20 is generally configured to removably receive the pole 100 and to support the pole 100. Pole 100 may be supported in a vertical orientation through support aperture 20. As illustrated, support aperture 20 is an enclosed lumen having a circular cross-section with a constant diameter or may have a square cross-section with a constant size. However, those skilled in the art will recognize that the inside size or diameter of support aperture 20 may taper (top to bottom or bottom to top) or may otherwise have a varying diameter along its length. Furthermore, upon review of the present disclosure, those skilled in the art will recognize that support tube 12 may have an alternatively shaped cross-section and pole 100 may have an alternatively shaped cross-section. Support aperture 20 may be otherwise shaped or have an open cross-section such as in the shape of a “C” or other shape or configuration capable of receiving and supporting pole 100 through support aperture 20. In one aspect, support aperture 20 may be sized and shaped compressionably receive pole 100 to securely hold and/or support pole 100. In another aspect, support aperture 20 may be sized to slidably receive and support pole 100. As will be recognized by one skilled in the art upon review of the present disclosure, support tube 12 may be composed of steel, aluminum, iron, nylon, carbon fiber, fiberglass, plastic or other material or composite of materials of sufficient mechanical strength and sized sufficiently to develop a structural integrity adequate to support pole 100.

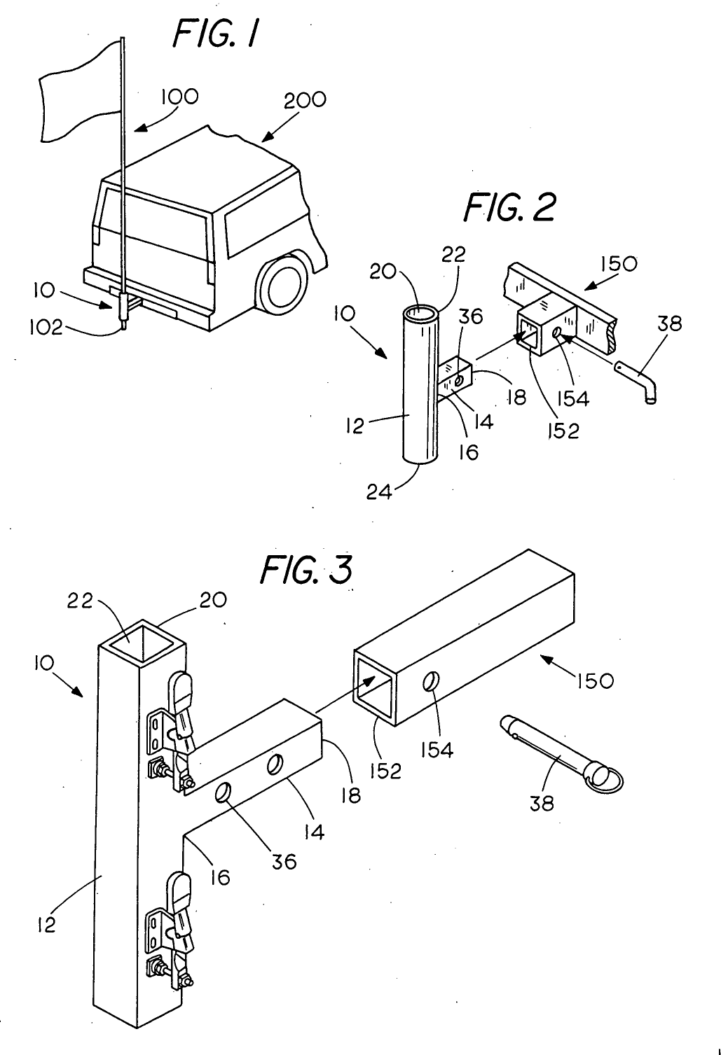

As illustrated in FIGS. 2 and 3, insert 14 is generally configured to be received within a receiver 152 of the trailer hitch assembly 150. Insert 14 includes an outside end 16 and an inside end 18. Inside end 18 is generally configured to fit inside receiver 152 of trailer hitch assembly 150. The cross-sectional shape as well as the size of inside end 18 of insert 14 typically correspond to an inside shape of receiver 152 such that inside end 18 may be slidably positioned within the receiver 152. As generally illustrated, inside end 18 of the insert 14 is of square cross-section and is sized to fit inside receiver 152 of trailer hitch assembly 150 to secure apparatus 10 to vehicle 200. Following insertion into the receiver 150, inside end 18 of insert 14 can be secured to the receiver 152 by one or more pins or bolts 38 through matched insert holes 36 and receiver holes 154 defined by the insert 14 and the receiver 152, respectively. The pins or bolts 38 can, in turn, be secured by cotter pin, clip, nut, or other securing element 40. Insert 14 may be hollow as generally illustrated in the figures or may be solid or otherwise configured. Outside end 16 of the insert 14 is secured support tube 12. Outside end 16 may be welded to, bolted to, molded to, or otherwise secured to the support tube 12. As will be recognized by one skilled in the art upon review of the present disclosure, insert 14 is typically composed of steel, aluminum, iron, nylon, carbon fiber, fiberglass, plastic or other material or composite of materials of sufficient mechanical strength and sized sufficiently to develop a structural integrity adequate to support pole 100.

In operation, pole 100 is positioned through support aperture 20 of support tube 12. In this position, pole 100 can be supported within the support tube 12 in a variety of ways as will be recognized by those skilled in the art. Butt 102 of pole 100 may rest upon the underlying surface. Accordingly, the weight of pole 100 may be, to varying degrees, supported by the underlying surface. Alternatively, butt 102 of pole 100 may be supported by apparatus 10 above the underlying surface. Regardless, support tube 12 stabilizes pole 100 at a desired angle from the underlying surface. The desired angle is frequently perpendicular to the plane defined by the underlying surface. Lateral forces and moments are carried by support tube 12 to varying degrees depending upon the particular configuration of apparatus 10. As generally illustrated in the Figures, at least a portion these lateral forces and moments are ultimately transferred to the receiver 152 of trailer hitch assembly 150. In embodiments where butt 102 contacts the ground, a portion of these lateral forces and moments will be transferred to the underlying surface.

In an embodiment illustrated in FIGS. 7 and 8, support aperture 20 of support tube 12 is lined with a sleeve 80. Sleeve 80 may be compressionably or slidably fitted within support aperture 20. Alternatively, sleeve 80 may be adhesively or mechanically (such as, for example, screwed, bolted or riveted) secured to support aperture 20. In one aspect, sleeve 80 may function to compressionally secure a pole 100 positioned through support aperture 20 of support tube 12. In another aspect, sleeve 80 may function to reduce the noise caused by movement of the flagpole. In yet another aspect, sleeve 80 may function to reduce wear and tear on a flagpole mounted through support aperture 20 of support tube 12. In still another aspect, sleeve 80 may serve as a spacer to secure the pole 100 within the support aperture 20. Sleeve 80 may be made from any number of materials depending upon the intended function. These materials may, for example, include rubber, soft plastic, vinyl, neoprene, or other compressible elastic material. Alternatively, sleeve 80 may be made from a substantially rigid material such as, for example, plastic, polyvinyl chloride, nylon, metal or other more rigid material. Sleeve 80 can include a first sleeve lip 82 at a first sleeve end 86 and a second sleeve lip 84 at a second sleeve end 88, as is generally illustrated in FIG. 7 for exemplary purposes. Alternatively, only a first sleeve lip 82 at a first sleeve end 86 may be provided on sleeve 80. First sleeve lip 82 and second sleeve lip 84 may generally hold sleeve 80 within the support tube 12.

In another aspect of the present invention illustrated in FIGS. 9 to 12, support tube 12 could be constructed of a first element 90 and a second element 92 connected by a hinge 44. Hinge 94 permits the movement of first element 90 and second element 92 between an opened position and a closed position. First element 90 and second element 42 include a first receiving surface 96 and a second receiving surface 98. First receiving surface 46 and a second receiving surface 98 are illustrated for exemplary purposes in a semi-circular configuration. In the closed position first receiving surface 96 and a second receiving surface 98 are positioned relative to one another to define the support aperture 20 to support pole 100 between the two components. In the opened position, first receiving surface 496 and a second receiving surface 98 are positioned relative to one another to permit the removal or insertion of pole 100.

The first receiving surface 96 and the second receiving surface 98 may include a first liner 56 and a second liner 58, respectively. First liner 56 and second liner 58 may be adhesively or mechanically (such as, for example, screwed, bolted or riveted) secured to first receiving surface 96 and the second receiving surface 98. In one aspect, first liner 56 and a second liner 58 may function to compressionally secure a pole 100 positioned through aperture 20 of support tube 12. In another aspect, first liner 56 and a second liner 58 may function to reduce the noise caused by movement of the flagpole. In yet another aspect, first liner 56 and a second liner 58 may function to reduce wear and tear on a flagpole mounted through support aperture 20. In still another aspect, first liner 56 and a second liner 58 may serve as a spacer to secure the pole 100 within the support aperture 20. First liner 56 and a second liner 58 may be made from any number of materials depending upon the intended function. These materials may, for example, include rubber, soft plastic, vinyl, neoprene, or other compressible elastic material. Alternatively, first liner 56 and a second liner 58 may be made from a substantially rigid material such as, for example, plastic, nylon, metal or other more rigid material.

The embodiment of FIGS. 9 to 12 may also include a latch assembly 50. Latch assembly 50 is configured to secure first element 90 and second element 92 in a closed position for supporting a pole 100. As illustrated for exemplary purposes, latch assembly 50 includes a plurality of “U” brackets 52 on each of the first element 90 and second element 92. “U” brackets 52 are brought into juxtaposition when the first element 90 and the second element 92 are in the closed position. A bolt 60 may then be inserted into the juxtaposed “U” brackets 52. A wingnut 62 may then be provided to secure the first element 90 and second element 92 in the closed position. Other configurations for latch 50 will be recognized by those skilled in the art upon review of the present disclosure. In the presently described embodiment, pole 100 may be inserted and secured between first element 90 and second element 92 without having to raise butt 102 of pole 100 above aperture 20 at first end 22 of support tube 12.

FIGS. 3, 13, 14 and 15 illustrate another embodiment of the present invention. As illustrated in FIGS. 3, 13, 14 and 15, apparatus 10 has a support aperture 20 having a square cross-sectional shape. Further, as illustrated, apparatus 10 includes a plurality of securing devices 158. For exemplary purposes, securing devices 158 are illustrated as mechanical clamps. Those skilled in the art will recognize a wide range of securing devices ranging from complex clamps to thumb screws may be implemented to secure a pole within apparatus 10. As illustrated, two securing devices 158 are positioned at an interval along a length of support tube 12. Again, as illustrated, a handle 160 of the securing device 158 is configured to rotate about a pin 164 to apply force by cantilever action on a rod 168. This force biases a holder 170 against the pole 100. The handle 160 may be configured to lock into place to thereby secure the pole within the holder. This fixably holds the pole 100 inside the support tube 12.

FIGS. 16 and 17 illustrate an embodiment of the present invention having a plurality of support tubes 12. A support member 74 can be welded to, bolted to, molded to, or otherwise secured to the outside end 16 of the insert 14. The plurality of vertical support tubes 12 can be welded to, bolted to, molded to, or otherwise secured to the horizontal member 74. Support member 74 may be made from steel or other materials having sufficient mechanical strength to support a plurality of flagpoles 100. The rotation of said embodiment of apparatus 10 by 90° within receiver 150 may form a ladder as illustrated in FIGS. 11 and 12. Following insertion into the receiver 150, inside end 18 of insert 14 can again be secured to the receiver 152 by one or more pins or bolts 38 through matched insert holes 36 and receiver holes 154 defined by the insert 14 and the receiver 152, respectively. Insert holes 36 may be provided in the insert 14 to align with receiver holes 154 in the receiver 152 upon said 90° rotation, so that the insert 14 may be secured to the receiver 152 by pins or bolts 38. Accordingly, the support tubes 12, insert 14, and member 74 may be configured with sufficient mechanical strength to act in concert as a ladder as would be recognized by one skilled in the art upon review of the present disclosure. In one aspect, support tubes 12 may be spaced at standard step intervals along the member 74. Further, the support tubes 12 could include a frictional material on at least a portion of their outer surface which has a high coefficient of friction to prevent slipping when using apparatus 10 as a ladder. In addition, handles could be attached to member 54 and/or support tubes 12 to better facilitate the use of apparatus 10 as a ladder and to conform to applicable safety requirements.

The present invention is not intended to be limited to the particular embodiments disclosed in this description. Upon review of the present disclosure, those skilled in the art should recognize that the present invention could be used to support a variety of devices such as satellite dish antenna and signs. For example, the embodiment of FIG. 16 shows an embodiment of apparatus 10 supporting an umbrella 176 having a square-shaped pole. Further, upon review of the description and Figures, it will be apparent to those skilled in the art that various modifications and variations can be made to the structure and method of the present invention without departing from the scope or spirit of the invention. In view of the foregoing, it is intended that the invention cover modifications and variations to the described embodiments that come within the scope of the claims and their equivalents.

What is claimed is:

1. An apparatus for supporting a flagpole, comprising:
an insert having an inner end and an outer end, the inner end configured to be received within the receiver of a trailer hitch assembly;
a support tube secured to the outer end of the insert, the support tube having a first end and a second end and defining a support aperture configured to removably receive a flagpole, the support aperture extending from the first end to the second end of the support tube to permit the flagpole to extend through the support aperture.

2. An apparatus, as in claim 1, further comprising a sleeve secured within the support aperture, the sleeve defining a sleeve aperture to receive the flagpole.

3. An apparatus, as in claim 2, further comprising the sleeve having a first sleeve lip at a first sleeve end of the sleeve, the first sleeve lip abutting the first end of the support tube to prevent the sleeve from passing through the support aperture of the support tube.

4. An apparatus, as in claim 1, the support tube comprising a first element and a second element, the first element movably secured to the second element by a hinge to allow the first element and the second element to be moved between an open position and a closed position, the first element having a first receiving surface and the second element having a second receiving surface, the first receiving surface and the second receiving surface defining the support aperture when the first element and the second element are positioned in the closed position.

5. An apparatus, as in claim 4, the support tube comprising a latch assembly to secure the first and the second element in a closed position.

6. An apparatus, as in claim 4, further comprising a first liner secured to the first receiving surface.

7. An apparatus, as in claim 6, further comprising a second liner secured to the second receiving surface.

8. An apparatus for supporting a flagpole, comprising:
an insert having an inner end and an outer end, the inner end configured to be received within the receiver of a trailer hitch assembly;
a support member secured to the outer end of the insert;
a plurality of support tubes secured to the support member, each of the plurality of support tubes having a first end and a second end and defining a support aperture configured to removably receive a flagpole, the support apertures extending from the first ends to the second ends of the support tubes to permit flagpoles to extend through the support apertures.

9. An apparatus, as in claim 8, further comprising a sleeve secured within each of the support apertures, the sleeve defining a sleeve aperture to receive the flagpole.

10. An apparatus, as in claim 9, further comprising the sleeve having a first sleeve lip at a first sleeve end of the sleeve, the first sleeve lip abutting the first end of the support tube to prevent the sleeve from passing through the support aperture of the support tube.

11. An apparatus, as in claim 8, the support tube comprising a first element and a second element, the first element movably secured to the second element by a hinge to allow the first element and the second element to be moved between an open position and a closed position, the first element having a first receiving surface and the second element having a second receiving surface, the first receiving surface and the second receiving surface defining the support aperture when the first element and the second element are positioned in the closed position.

12. An apparatus, as in claim 11, the support tube comprising a latch assembly to secure the first and the second element in a closed position.

13. An apparatus, as in claim 11, further comprising a first liner secured to the first receiving surface.

14. An apparatus, as in claim 13, further comprising a second liner secured to the second receiving surface.

15. A method, comprising:
providing an apparatus for supporting the flagpole, including an insert having an inner end and an outer end, the inner end configured to be received within the receiver of a trailer hitch assembly; and a support tube secured to the outer end of the insert, the support tube having a first end and a second end and defining a support aperture configured to removably receive a flagpole, the support aperture extending from the first end to the second end of the support tube to permit the flagpole to extend through the support aperture;
securing the outer end of the insert into a receiver of a trailer hitch assembly; and
positioning the flagpole through the support aperture of the support tube.
